(19) United States
(12) Patent Application Publication
(10) Pub. No.: US 2022/0106140 A1
(43) Pub. Date: Apr. 7, 2022

(54) DIRECTIONAL GEAR AND MANUAL PAPER FEEDING DEVICE HAVING THE SAME

(71) Applicant: FANER AROMA PRODUCT CO., LTD., Guangzhou (CN)

(72) Inventors: HSU-HUI CHANG, New Taipei City (TW); YINGYAO LIU, Guangzhou (CN)

(21) Appl. No.: 17/551,133

(22) Filed: Dec. 14, 2021

Related U.S. Application Data
(63) Continuation-in-part of application No. 16/987,422, filed on Aug. 7, 2020.

(51) Int. Cl. B65H 3/06; F16H 57/00

(52) U.S. Cl. CPC B65H 3/0669; B65H 2403/941; B65H 2403/42; F16H 57/0025

(57) ABSTRACT

A directional gear is adapted to be fitted to a driving shaft and includes a driving element, an external gear and a plurality of catching elements. The driving element is fitted to the driving shaft. A plurality of receiving slots are disposed at the periphery of the driving element. The external gear is disposed radially outside the driving element and includes a ring-shaped body and a plurality of tilted inner teeth. The tilted inner teeth are connected to the inner side of the ring-shaped body. The catching elements are movably disposed in the receiving slots and each include a catching portion corresponding in shape to the corresponding tilted inner teeth. The catching elements are selectively engaged with at least one of the tilted inner teeth of the external gear through the catching portions.

### CROSS-REFERENCE TO RELATED APPLICATION

This application is a continuation-in-part patent application of U.S. application Ser. No. 16/987,422 filed on Aug. 7, 2020, the entire contents of which are hereby incorporated by reference for which priority is claimed under 35 U.S.C. § 120.

### BACKGROUND OF THE INVENTION

### 1. Field of the Invention

The present disclosure relates to gears, and in particular to a directional gear driven in one direction and idling in the other direction.

### 2. Description of the Related Art

Gears are mechanical components widely used in daily life and industries. In general, a drive gear fitted to a driving shaft not only undergoes rotation together with the driving shaft freely, whether forward or reverse, but also drives driven gears (which mesh with the drive gear) to rotate and thus drive the entire mechanism. However, in some circumstances, users or manufacturers expect that the drive gear will not only rotate in a specific direction together with the driving shaft but also stay at the initial position and thus idle when the driving shaft rotates reversely. The aforesaid expectation is partially met with mechanical components, such as a ratchet. However, the ratchet in operation changes linear reciprocating motion and rotation motion to unidirectional step motion. As a result, the gear is unable to operate at a high working frequency, but generates noise and vibration while operating. Furthermore, in the event of a heavy load for the transmission mechanism, the gear cannot be replaced with a ratchet.

### BRIEF SUMMARY OF THE INVENTION

An objective of the present disclosure is to provide a directional gear driven in one direction and idling in the other direction, so as to attain high working frequency, high transmission load and unidirectional rotation.

To achieve at least the above objective, the present disclosure provides a directional gear adapted to be fitted to a driving shaft and comprising a driving element, an external gear and a plurality of catching elements. The driving element is fitted to the driving shaft. A plurality of receiving slots are disposed at the periphery of the driving element. The external gear is disposed radially outside the driving element and comprises a ring-shaped body and a plurality of tilted inner teeth. The tilted inner teeth are connected to the inner side of the ring-shaped body. The catching elements are movably disposed in the receiving slots and each comprise a catching portion. The catching portions correspond in shape to the tilted inner teeth. The catching elements are selectively engaged with at least one of the tilted inner teeth of the external gear through the catching portion.

In an embodiment, the tilted inner teeth each have a first face and a second face. When the catching elements are engaged with the external gear, the catching portions of the catching elements mesh with the first face and second face of two adjacent ones of the tilted inner teeth.

In an embodiment, the first faces and second faces of the tilted inner teeth are connected to a root circle defined partially at the ring-shaped body, such that a first angle and a second angle greater than the first angle are formed between a tangential surface of the root circle and each said first face and each said second face, respectively.

In an embodiment, the first angle is an acute angle, and the second angle is a right angle or obtuse angle.

In an embodiment, the plurality of receiving slots each have a first stop portion and a second stop portion, and the plurality of catching elements each further comprise a first pressing portion and a second pressing portion, wherein the at least one catching element is engaged with the at least one tilted inner tooth when the first pressing portion of at least one catching element of the plurality of catching elements presses against the first stop portion of the receiving slot, and the at least one catching element is disengaged from the at least one tilted inner tooth when the second pressing portion of the at least one catching element presses against the second stop portion of the receiving slot.

In an embodiment, the plurality of receiving slots each further have a pivotal hole, and the plurality of catching elements each further comprise a pivotal portion disposed in a corresponding one of the pivotal holes, wherein the plurality of catching elements rotate relative to the driving element through the pivotal portions when the driving shaft drives the driving element to rotate.

In an embodiment, the first stop portion and second stop portion are disposed on two different sides of the pivotal hole, respectively, whereas the first pressing portion and the second pressing portion are disposed on two different sides of the pivotal portion, respectively.

In an embodiment, a through hole is disposed on each said catching element.

In an embodiment, the receiving slots are equidistantly disposed at the periphery.

Therefore, a directional gear of the present disclosure allows catching portions of catching elements to be selectively engaged with tilted inner teeth of an external gear, such that a driving element and catching elements drive the external gear to rotate when a driving shaft rotates in a direction. The driving shaft rotating in another direction and the external gear idle relative to each other, allowing the external gear to stay at its initial position, so as to achieve unidirectional rotation.

### BRIEF DESCRIPTION OF THE DRAWINGS

FIG. 1 is a perspective view of a directional gear according to an embodiment of the present disclosure.

FIG. 2 is an exploded view of the directional gear of FIG. 1.

FIG. 3 is a front cross-sectional view of FIG. 1.

FIG. 4 is an enlarged view of tilted inner teeth shown in FIG. 3.

FIG. 5 is a schematic diagram of a manual paper feeding device disposed in a paper dispenser according to an embodiment of the present disclosure.

FIG. 6 is an exploded view of a manual paper feeding device disposed in a paper dispenser according to an embodiment of the present disclosure.

FIG. 7 is an exploded view of a manual paper feeding device disposed in a paper dispenser according to an embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

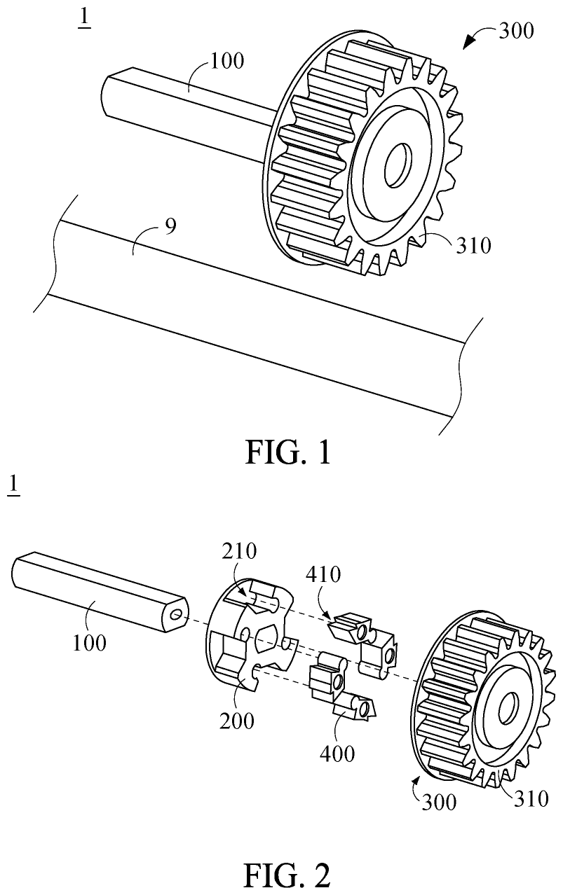

Referring to FIG. 1 and FIG. 2, FIG. 1 is a perspective view of a directional gear according to an embodiment of the present disclosure, and FIG. 2 is an exploded view of the directional gear of FIG. 1. A directional gear 1 in this embodiment is adapted to be fitted to a driving shaft 100 and comprises a driving element 200, an external gear 300 and a plurality of catching elements 400. The driving element 200 is fitted to driving shaft 100 and perpendicular to the driving shaft 100. A plurality of receiving slots 210 are disposed at the periphery of driving element 200. The external gear 300 is disposed radially outside driving element 200. The catching elements 400 are movably disposed in receiving slots 210.

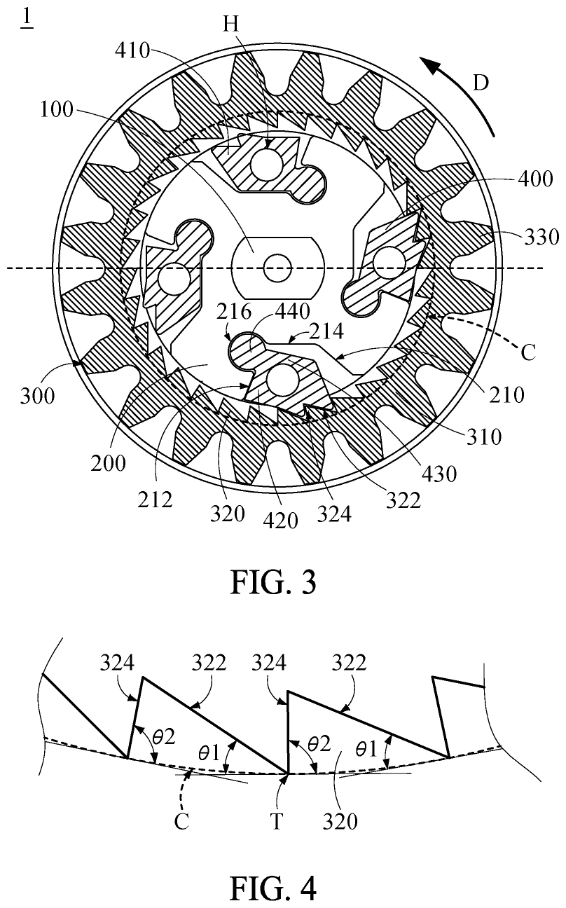

Referring to FIG. 3, there is shown a front cross-sectional view of FIG. 1. The driving shaft 100 is connected to a motor (not shown) or any other power mechanism to provide the torque required for rotation of driving element 200 and external gear 300. Preferably, the cross section of driving shaft 100 are in any geometric shape (for example, square, oval or round-cornered rectangular shape) except for round shape. Consequently, when driving shaft 100 rotates, driving element 200 rotates synchronously with driving shaft 100 without sliding relative thereto, so as to enhance transmission efficiency. In any other possible embodiment, driving shaft 100 and driving element 200 are fixed to each other, for example, by being adhered or welded to each other or being integrally formed, so as to enhance transmission efficiency.

In this embodiment, receiving slots 210 are equidistantly disposed at the periphery of driving element 200, such that driving element 200 has a H-shaped cross section. Consequently, the center of gravity of the driving element 200 is at driving shaft 100, precluding eccentric rotation and uneven load. The external gear 300 comprises a ring-shaped body 310, a plurality of tilted inner teeth 320 and a plurality of outer teeth 330. The tilted inner teeth 320 are connected to the inner side of the ring-shaped body 310. The outer teeth 330 are connected to the outer side of the ring-shaped body 310. In this embodiment, tilted inner teeth 320 engage with and mesh with catching elements 400, such that driving shaft 100 drives external gear 300 to rotate, and external gear 300 operates through the coupling of outer teeth 330 to any other transmission components.

The catching elements 400 each comprise a catching portion 410. The catching portions 410 correspond in shape to the tilted inner teeth 320. The catching elements 400 are selectively engaged with at least one tilted inner tooth 320 of external gear 300 through the catching portion 410. The plurality of catching elements 400 move parallel to the driving element 200, and there is no element disposed between the plurality of catching elements 400 and the driving element 200 so to simplify the structure. As shown in FIG. 3, the driving shaft 100 in this embodiment is parallel to the ground 9. When driving shaft 100 drives driving element 200 to rotate in direction D, catching portions 410 of catching elements 400 (below the horizontal dashed line in FIG. 3) located to the right of the driving shaft 100 and below the driving shaft 100 automatically protrude from the receiving slots 210 and are engaged with the tilted inner teeth 320 under gravity and centrifugal force, respectively. When the centrifugal force keeps increasing, catching portions 410 of catching elements 400 (above the horizontal dashed line in FIG. 3) located to the left of the driving shaft 100 and above the driving shaft 100 automatically protrude from the receiving slots 210 and are engaged with the tilted inner teeth 320. When the driving shaft 100 drives the driving element 200 to rotate in a direction opposite to direction D, the catching elements 400 are not engaged with tilted inner teeth 320 and thus continue to be driven by the driving element 200, because the contact surface between each catching portion 410 of catching elements 400 and the corresponding one of the tilted inner teeth 320 extends forward. Therefore, in the course of the rotation of the directional gear 1, catching elements 400 are engaged with and disengaged from tilted inner teeth 320 repeatedly to preclude the likelihood of stress concentration and component damage otherwise caused by persistent engagement of each catching element 400 and the corresponding tilted inner tooth 320. The directional gear of the present disclosure greatly reduces the generation of noise by allowing the catching elements 400 to be engaged with and disengaged from the tilted inner teeth 320 repeatedly. Although, in this embodiment, the driving shaft 100 is parallel to the ground, and catching elements 400 are engaged with tilted inner teeth 320 under gravity and centrifugal force, the present disclosure is not limited thereto. For instance, with the driving shaft 100 perpendicular to the ground 9, and the external gear 300 parallel to the ground 9 while rotating, the catching portions 410 of catching elements 400 can still be automatically engaged with the tilted inner teeth 320 under centrifugal force when the driving shaft 100 drives the driving element 200 to rotate in direction D. When the driving shaft 100 drives the driving element 200 to rotate in a direction opposite to direction D, the catching elements 400 are not engaged with the tilted inner teeth 320, because the contact surface between each catching portion 410 of catching elements 400 and the corresponding one of the tilted inner teeth 320 extends forward. Therefore, the directional gear of the present disclosure is capable of greatly reducing the generation of noise, because the catching elements 400 are engaged with and disengaged from tilted inner teeth 320 repeatedly.

As shown in FIG. 3, the receiving slots 210 each have a first stop portion 212, a second stop portion 214 and a pivotal hole 216. The first stop portion 212 and second stop portion 214 are disposed on two different sides of the pivotal hole 216, respectively. The catching elements 400 each comprise a first pressing portion 420, a second pressing portion 430 and a pivotal portion 440. The first pressing portion 420 and second pressing portion 430 are disposed on two different sides of the pivotal portion 440, respectively. The pivotal portions 440 are disposed in the pivotal holes 216. When the driving shaft 100 drives the driving element 200 to rotate, the catching elements 400 rotate relative to driving element 200 through pivotal portions 440. When first pressing portions 420 of catching elements 400 press against first stop portions 212 of receiving slots 210, respectively, catching portions 410 of catching elements 400 protrude relative to receiving slots 210, allowing catching elements 400 to be engaged with tilted inner teeth 320. When second pressing portions 430 of catching elements 400 press against second stop portions 214 of receiving slots 210, respectively, catching portions 410 of catching elements 400 are received in receiving slots 210, allowing catching elements 400 to be disengaged from tilted inner teeth 320. Therefore, catching elements 400 are selectively engaged or disengaged from tilted inner teeth 320 through pivotal portions 440. In the engaged state and disengaged state, each pressing portion and a corresponding stop portion press against each other, such that catching elements 400 attain stable balance. Preferably, a through hole H is formed on each catching element 400, such that the weight of catching elements 400 is concentrated at first pressing portions 420 and second pressing portions 430. When directional gear 1 rotates, the catching elements 400 have the first pressing portions 420 pressing against the first stop portions 212 and the second pressing portions 430 pressing against the second stop portions 214 quickly to switch between the engaged state and disengaged state and thus reduce the time taken to transit between the aforesaid two states.

The transition between the engaged state and disengaged state is not necessarily achieved through pivotal connection to the driving element 200. For instance, the receiving slots 210 may also be designed to face radial grooves disposed at the periphery of the driving element 200, and the catching elements 400 are sliders slidingly disposed in the radial grooves. When rotation speed is increased to augment the centrifugal force, the catching portions 410 of catching elements 400 slide out of the receiving slots 210 under the centrifugal force and thus engage with the inner teeth 320. When rotation speed is decreased to diminish the centrifugal force, the catching elements 400 slide into the receiving slots 210 and thus disengage from the inner teeth 320. However, the present disclosure is not limited thereto.

Referring to FIG. 3 and FIG. 4, FIG. 4 is an enlarged view of tilted inner teeth shown in FIG. 3. As shown in the diagram, in this embodiment, tilted inner teeth 320 are not upright (being upright means their tops pointing at the center of the driving shaft 100) but are as slant as a ratchet. The tilted inner teeth 320 each have a first face 322 and a second face 324. As shown in FIG. 3, the catching portions 410 of catching elements 400 mesh with the first face 322 and second face 324 of two adjacent ones of the tilted inner teeth 320 when catching elements 400 are engaged with the external gear 300. The first faces 322 and second faces 324 of tilted inner teeth 320 are connected to a root circle C defined partially at the ring-shaped body 310. As shown in FIG. 4, a first angle θ1 and a second angle θ2 are formed between tangential surface T of the root circle C and the first face 322 and second face 324 of each tilted inner tooth 320, respectively. The first angle θ1 is less than the second angle θ2. Preferably, the first angle θ1 is an acute angle, and the second angle θ2 is a right angle or obtuse angle. When the driving shaft 100 drives the driving element 200 to rotate in direction D shown in FIG. 3, catching elements 400 are engaged with the second faces 324 of tilted inner teeth 320 and thus drive external gear 300 to synchronously rotate in direction D. However, when the driving shaft 100 drives the driving element 200 to rotate in a direction opposite to direction D, the second face 324 facing the first angle θ1 is so low that the catching portion 410 slides across the first face 322 and thus directly passes the tilted inner teeth 320 without engaging with it, thereby allowing the driving element 200 and external gear 300 to idle and allowing external gear 300 to stay at its initial position, so as to achieve unidirectional rotation.

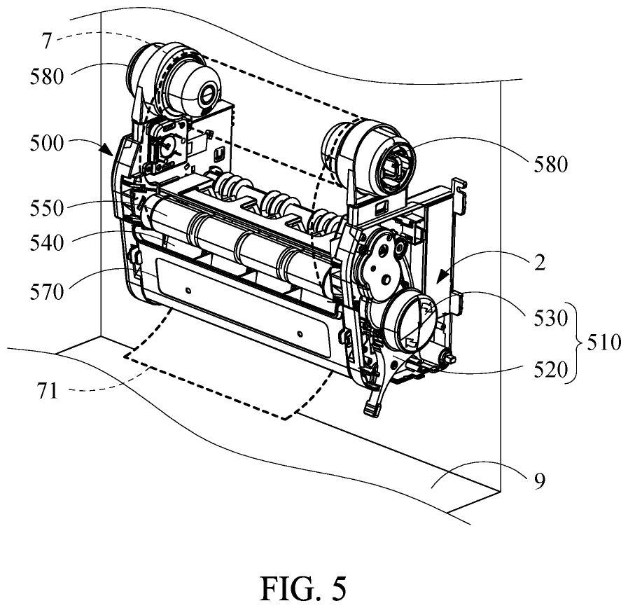

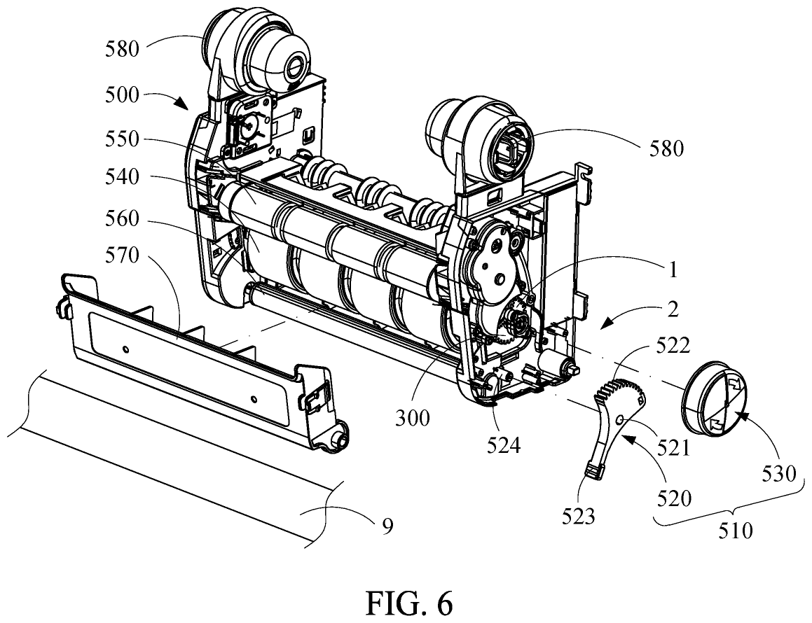

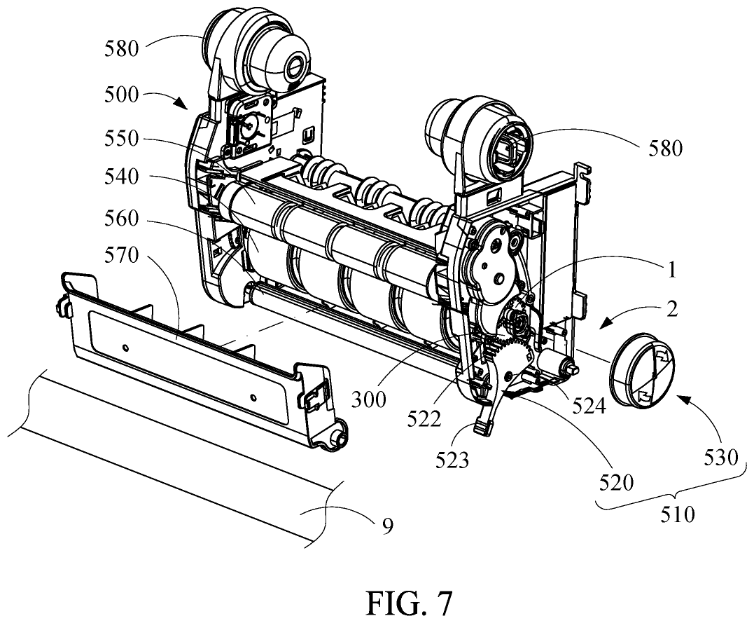

Please refer to FIG. 5 to FIG. 7. FIG. 5 is a schematic diagram of a manual paper feeding device 2 disposed in a paper dispenser 500 according to an embodiment of the present disclosure. FIG. 6 is an exploded view of the manual paper feeding device of FIG. 5. FIG. 7 is another exploded view of the manual paper feeding device of FIG. 5. In this embodiment, the manual paper feeding device 2 is suitable for being installed in a paper dispenser 500. The paper dispenser 500 may have a paper distribution roller 540, an upper auxiliary roller 550, a lower auxiliary roller 560, a cover 570, and two paper roll positioning portions 580. A paper roll 7 is positioned between the paper roll positioning portions 580. The surface of the paper distribution roller 540, the surface of the upper auxiliary roller 550 and the surface of the lower auxiliary roller 560 have a rubber material to drive a movement of a paper 71 of the paper roll 7. The paper 71 of the paper roll 7 can be wound from the front side of the paper dispenser 500 through the upper auxiliary roller 550 and the paper distribution roller 540 to the back side of the paper distribution roller 540. The paper 71 is then wound from the back side of the paper distribution roller 540 to the front side of the paper distribution roller 540, passes between the paper distribution roller 540 and the lower auxiliary roller 560, and is sent out below the cover 570. Also, please refer to FIG. 1 to FIG. 3. The manual paper feeding device 2 includes the aforementioned directional gear 1 and a manual part 510. The directional gear 1 is disposed on one side of the paper dispenser 500, and the driving shaft 100 of the directional gear 1 is connected to the shaft center of the paper distribution roller 540 to drive the paper distribution roller 540 to rotate. The manual part 510 and the directional gear 1 are disposed on the same side of the paper dispenser 500 to drive the external gear 300 of the directional gear 1 to rotate.

Please refer to FIG. 1, FIG. 3 and FIGS. 5-7. The driving shaft 100 is parallel to the ground 9, the driving element 200 is perpendicular to the driving shaft 100, and the catching elements 400 move parallel to the driving element 200. Thus, the catching elements 400 located below the horizontal dashed line in FIG. 3 are engaged with tilted inner teeth 320 of the external gear 300 under gravity. When the manual part 2 drives the external gear 300 of the directional gear 1 to rotate clockwise, the external gear 300 can drive the driving element 200, the driving shaft 100 and the paper distribution roller 540 to rotate via the catching elements 400, such that the paper distribution roller 540 sends out the paper 71.

Please refer to FIG. 5 to FIG. 7. In this embodiment, the manual part 510 may have a pulling portion 520. The pivoting hole 521 between the two ends of the pulling portion 520 is pivotally connected to the pivoting shaft 524 at one side of the paper dispenser 500. The two ends of the pulling portion respectively 520 have an arc-shaped tooth surface 522 and a pulling rod 523, and the arc-shaped tooth surface 522 is engaged with the external gear 300. Please refer to FIG. 7. When the user presses the pulling rod 523 downward, the arc-shaped tooth surface 522 moves counterclockwise to drive the external gear 300 to rotate clockwise, such that the paper distribution roller 540 sends out the paper 71.

Please refer to FIG. 5 to FIG. 7. In this embodiment, the manual part 510 may have a rotating portion 530 connected to the external gear 300 by the top of the external gear 300. Please refer to FIG. 7. When the user rotates the rotating portion 530 clockwise, the rotating portion 530 drives the external gear 300 to rotate clockwise, such that the paper distribution roller 540 sends out the paper 71.

While the present disclosure has been described by means of specific embodiments, numerous modifications and variations could be made thereto by those skilled in the art without departing from the scope and spirit of the present disclosure set forth in the claims.

What is claimed is:

1. A directional gear, comprising:
a driving shaft being parallel to ground;
a driving element fitted to the driving shaft and being perpendicular to the driving shaft, wherein a plurality of receiving slots are disposed at a periphery of the driving element;
an external gear disposed radially outside the driving element and comprising:
a ring-shaped body; and
a plurality of tilted inner teeth connected to an inner side of the ring-shaped body; and
a plurality of catching elements movably disposed in the plurality of receiving slots and each comprising a catching portion, the catching portions corresponding in shape to the plurality of tilted inner teeth, and the plurality of catching elements being selectively engaged with at least one tilted inner tooth of the external gear through the catching portions, wherein the plurality of catching elements move parallel to the driving element, and there is no element disposed between the plurality of catching elements and the driving element.

2. The directional gear of claim 1, wherein the plurality of tilted inner teeth each have a first face and a second face, wherein the catching portion of the at least one catching element meshes with the first face and the second face of two adjacent ones of the plurality of tilted inner teeth when at least one of the plurality of catching elements is engaged with the external gear.

3. The directional gear of claim 2, wherein the first faces and the second faces of the plurality of tilted inner teeth are connected to a root circle defined partially at the ring-shaped body, such that a first angle and a second angle greater than the first angle are formed between a tangential surface of the root circle and each said first face and each said second face, respectively.

4. The directional gear of claim 3, wherein the first angle is an acute angle, and the second angle is a right angle or obtuse angle.

5. The directional gear of claim 1, wherein the plurality of receiving slots each have a first stop portion and a second stop portion, and the plurality of catching elements each further comprise a first pressing portion and a second pressing portion, wherein the at least one catching element is engaged with the at least one tilted inner tooth when the first pressing portion of at least one catching element of the plurality of catching elements presses against the first stop portion of the receiving slot, and the at least one catching element is disengaged from the at least one tilted inner tooth when the second pressing portion of the at least one catching element presses against the second stop portion of the receiving slot.

6. The directional gear of claim 5, wherein the plurality of receiving slots each further have a pivotal hole, and the plurality of catching elements each further comprise a pivotal portion disposed in a corresponding one of the pivotal holes, wherein the plurality of catching elements rotate relative to the driving element through the pivotal portions when the driving shaft drives the driving element to rotate.

7. The directional gear of claim 6, wherein the first stop portion and the second stop portion are disposed on two different sides of the pivotal hole, respectively, whereas the first pressing portion and the second pressing portion are disposed on two different sides of the pivotal portion, respectively.

8. The directional gear of claim 1, wherein a through hole is disposed on each said catching element.

9. The directional gear of claim 1, wherein the plurality of receiving slots are equidistantly disposed at the periphery.

10. A manual paper feeding device disposed in a paper dispenser, in which the paper dispenser includes a paper distribution roller, the manual paper feeding device comprising:
the directional gear of claim 1, wherein the driving shaft of the directional gear is connected to the paper distribution roller; and
a manual part, configured to drive the external gear of the directional gear.

11. The manual paper feeding device of claim 10, wherein the manual part includes a pulling portion, the paper dispenser is pivotally connected between two ends of the pulling portion, the two ends of the pulling portion respectively have an arc-shaped tooth surface and a pulling rod, and the arc-shaped tooth surface is engaged with the external gear.

12. The manual paper feeding device of claim 10, wherein the manual part includes a rotating portion connected to the external gear.
